(19) United States
(12) Patent Application Publication
(10) Pub. No.: US 2026/0189911 A1
(43) Pub. Date: Jul. 2, 2026

(54) HARDWARE LAYER USER DEVICE SECURITY IN WIRELESS COMMUNICATION NETWORKS

(71) Applicant: T-MOBILE INNOVATIONS LLC, Overland Park, KS (US)

(72) Inventors: Geoffrey Todd Gibson, Rowlett, TX (US); Jeffrey Scott Simon, JR., Issaquah, WA (US); Gaurav Madan, Issaquah, WA (US); Shawn David Corey, Kenmore, WA (US)

(21) Appl. No.: 19/008,376

(22) Filed: Jan. 2, 2025

(51) Int. Cl. H04W 12/06; H04W 12/033; H04W 12/088; H04W 60/00

(52) U.S. Cl. CPC H04W 12/068; H04W 12/033; H04W 12/088; H04W 60/00

(57) ABSTRACT

Various embodiments include a system that comprises radio circuitry, processing circuitry, and user circuitry of a wireless user device. The radio circuitry wirelessly transfers a registration request to a wireless communication network to register and receive wireless data service. The processing circuitry utilizes security credentials provisioned to the wireless user device to establish an encrypted tunnel with an external gateway over the wireless communication network. The security credentials are stored in a processing circuitry memory that is isolated from the user circuitry. The radio circuitry wirelessly transfers a session request to the wireless communication network for a data session with the external gateway. The user circuitry configured to generate user data for the data session. The processing circuitry routes user data for the data session through the encrypted tunnel to the external gateway.

### TECHNICAL FIELD

Various embodiments of the present technology relate to data security, and more specifically, to hardware layer encryption for wireless user devices.

### BACKGROUND

Wireless communication networks provide wireless data services to wireless user devices. Exemplary wireless data services include voice calling, video calling, internet-access, media-streaming, online gaming, social-networking, and machine-control. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices.

A user device may engage in data sessions with an application server over a wireless communication network. To increase session security, some application servers require end-to-end encryption between the user device and the application server. For example, the user device may utilize a Virtual Private Network (VPN) service to create a secure tunnel over the wireless communication network between the user device and the application server. To set up the secure tunnel, the user device undergoes a handshake process (e.g., a Transport Layer Security (TLS) handshake) with the application server. During the handshake process, the user device and application server verify each other's identities and derive cryptography keys which are used to encrypt/decrypt data exchanged over the secure tunnel. Once the tunnel is set up, the user device exchanges encrypted communications with the application server over the wireless communication network.

While communications between the application server and user device are encrypted after the handshake process, the initial communications between the user device and application server are typically not encrypted. This can result in sensitive information about the server like Internet Protocol (IP) address, Domain Name Server (DNS) request/response information, and server name to be exposed. Malicious actors may obtain and use this exposed information to target the enterprise associated with the application server, to participate in a man-in-the-middle attack, or to perform other malicious actions.

### OVERVIEW

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for data security. Some embodiments comprise a method. The method comprises wirelessly transferring, by a wireless user device, a registration request to a wireless communication network to register with the wireless communication network for wireless data service. The method further comprises responsive to network registration, utilizing, by the wireless user device, security credentials provisioned to the wireless user device prior to the network registration to establish an encrypted tunnel with an external gateway over the wireless communication network. The security credentials are stored in a memory in processing circuitry in the wireless user device and the memory in the processing circuitry is isolated from user circuitry in the wireless user device. The method further comprises wirelessly transferring, by the wireless user device, a session request to the wireless communication network for a data session with the external gateway. The method further comprises routing, by the wireless user device, user data for the data session through the encrypted tunnel to the external gateway. The user circuitry generates the user data for the data session and the processing circuitry routes the user data through the encrypted tunnel to the external gateway.

Some embodiments comprise a system. The system comprises radio circuitry, processing circuitry, and user circuitry in a wireless user device. The processing circuitry generates a registration request to register with a wireless communication network for wireless data service. The radio circuitry wirelessly transfers the registration request to the wireless communication network. The processing circuitry utilizes, responsive to network registration, security credentials provisioned to the wireless user device prior to the network registration to establish an encrypted tunnel with an external gateway over the wireless communication network. The security credentials are stored in a memory in the processing circuitry and the memory in the processing circuitry is isolated from user circuitry in the wireless user device. The processing circuitry generates a session request for a data session with the external gateway. The radio circuitry wirelessly transfers the session request to the wireless communication network. The user circuitry generates user data for the data session. The processing circuitry routes the user data for the data session through the encrypted tunnel to the external gateway.

Some embodiments comprise one or more non-transitory computer readable storage media having program instructions stored thereon. When executed by a computing system, the program instructions direct the computing system to perform operations. The operations comprise directing a radio of a wireless user device to wirelessly transfer a registration request to a wireless communication network to register with the wireless communication network for wireless data service. The operations further comprise, responsive to network registration, utilizing security credentials provisioned to the wireless user device prior to the network registration to establish an encrypted tunnel with an external gateway over the wireless communication network. The security credentials are stored in a memory in processing circuitry in the wireless user device and the memory in the processing circuitry is isolated from user circuitry in the wireless user device. The operations further comprise directing the radio to wirelessly transfer a session request to the wireless communication network for a data session with the external gateway. The operations further comprise routing user data for the data session through the encrypted tunnel to the external gateway. The user circuitry generates the user data for the data session and the processing circuitry routes the user data through the encrypted tunnel to the external gateway.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an example communication network to provide end-to-end security using wireless user device hardware layer encryption.

FIG. 2 illustrates a first exemplary operation of the communication network to provide end-to-end security using wireless user device hardware layer encryption.

FIG. 3 illustrates a second exemplary operation of the communication network to provide end-to-end security using wireless user device hardware layer encryption.

FIG. 4 illustrates a third exemplary operation of the communication network to provide end-to-end security using wireless user device hardware layer encryption.

FIG. 5 illustrates an example Fifth Generation (5G) communication network to provide end-to-end security using User Equipment (UE) hardware layer encryption.

FIG. 6 illustrates an example 5G UE in the 5G communication network that provides end-to-end security using UE hardware layer encryption.

FIG. 7 illustrates an example 5G Radio Access Network (RAN) in the 5G communication network that provides end-to-end security using UE hardware layer encryption.

FIG. 8 illustrates an example 5G data center in the 5G communication network that provides end-to-end security using UE hardware layer encryption.

FIG. 9 further illustrates the example 5G data center in the 5G communication network that provides end-to-end security using UE hardware layer encryption.

FIG. 10 illustrates an exemplary operation of the 5G communication network to provide end-to-end security using UE hardware layer encryption.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

In a conventional wireless communication network, a user device may participate in a data session (e.g., a Protocol Data Unit (PDU) session) with an application server external to the wireless communication network. The user device may establish an end-to-end encrypted tunnel with the application server that traverses the wireless communication network to increase session security. Exemplary security protocols that may be used to establish the encrypted tunnel include Transport Layer Security (TLS) and Secure Sockets Layer (SSL). The user device and the application server participate in a handshake process to create the end-to-end encrypted tunnel. During the handshake process, the user device and the application select cryptography algorithms to be used for the session, verify each other's identities (e.g., using digital certificates), and derive cryptography keys for the session. Once the handshake process is complete, the user device exchanges encrypted communications with the application server over the encrypted tunnel that traverses the wireless communication network.

While the end-to-end encrypted tunnel ensures communications between the application server and user device are safe, the initial communications to create the tunnel are not encrypted. This can result in sensitive information about the server like Internet Protocol (IP) address, Domain Name Server (DNS) request/response information, and server name to be exposed. Malicious actors may obtain this information. If the malicious actor is able to successfully penetrate the enterprise associated with the application server, the malicious actor may use this information to target key servers in the enterprise. Additionally, the malicious actor may use this information to participate in a man-in-the-middle attack between the user device and the application server.

To overcome the above-described problems in conventional wireless communication networks, various embodiments of the present technology relate to hardware layer user device security. The user device includes processing circuitry that is provisioned with security credentials. For example, the processing circuitry may comprise a baseband chipset, a Trusted Platform Module (TPM), and the like. These security credentials are stored in an isolated memory of the user device. The isolated memory is not accessible by the user device's operating system which prevents tampering. After initial network registration and before the start of its data session, the user device uses the provisioned security credentials to establish an end-to-end encrypted tunnel over the communication network with an external gateway (e.g., an application server). The provisioning of the security credentials allows the user device to bypass the handshake process thereby reducing the risk of sensitive data exposure. Now referring to the Figures.

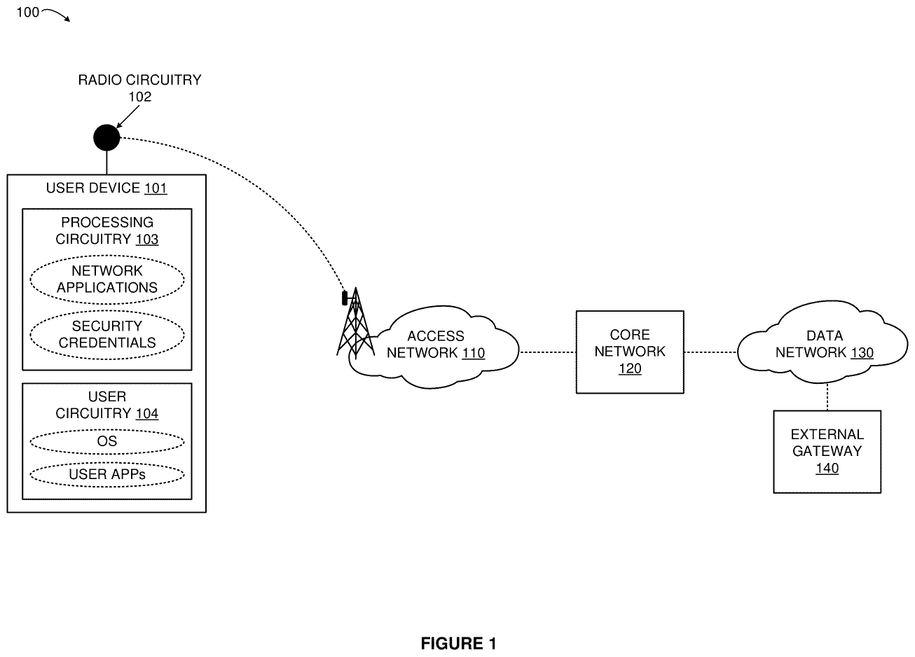

FIG. 1 illustrates communication network 100 to provide end-to-end security using wireless user device hardware layer encryption. Communication network 100 provides services like media-streaming, media-broadcasting, internet-access, voice/video calling, text messaging, online gaming, social media, machine communications, remote device control, or some other wireless communications product. Communication network 100 comprises user device 101, access network 110, core network 120, data network 130, and external gateway 140. User device 101 comprises radio circuitry 102, processing circuitry 103, and user circuitry 104. Processing circuitry 103 hosts network applications and stores security credentials. User circuitry 104 hosts an operating system (OS) and user applications (APPs). In other examples, communication network 100 may comprise additional or different elements than those illustrated in FIG. 1.

Various examples of network operation and configuration are described herein. In some examples, user device 101 powers on and wirelessly attaches to access network 110. User device 101 generates a registration request to receive wireless data service and wirelessly transfers the registration request to access network 110. Access network 110 forwards the request to core network 120. For example, processing circuitry 103 may execute the network applications to establish a wireless connection with access network 110 over radio circuitry 102 and transfer the registration request over the wireless connection. Core network 120 authenticates user device 101, authorizes user device 101 for wireless data service on communication network 100, and registers user device 101 with communication network 100.

Responsive to network registration, user device 101 uses the security credentials stored in processing circuitry 103 to establish an encrypted tunnel with external gateway 140 over access network 110, core network 120, and data network 130. For example, processing circuitry 103 may be representative of a baseband chipset and/or Trusted Platform Module (TPM) that uses the security credentials to create the encrypted tunnel with external gateway 140. User device 101 may include the security credentials in the registration request to create the encrypted tunnel as part of the registration process. The security credentials may comprise cryptography keys, digital certificates, and the like. The security credentials are provisioned to user device 101 during device activation (e.g., after device purchase) prior to network registration. The security credentials are stored by a memory in processing circuitry 103. The memory in processing circuitry 103 is isolated from user circuitry 104. The memory isolation inhibits user circuitry 104, the operating system of user circuitry 104, and user applications executed by user circuitry 104 from accessing or otherwise tampering with the security credentials. The isolation also inhibits the user of user device 101 from accessing the security credentials thereby increasing their immutability. By establishing an encrypted tunnel after initial network attachment using provisioned security credentials, user device 101 avoids exposing sensitive information like IP address, DNS request/response information, and server name which are typically not protected during the handshake process to setup the encrypted tunnel.

Once the encrypted tunnel is set up, user device 101 launches one of the user applications and generates a session request (e.g., a PDU request) for a wireless data session on communication network 100 with external gateway 140. User device 101 wirelessly transfers the session request to access network 110 which forwards the request to core network 120. Core network 120 organizes hardware and software resources to support the data session. Core network 120 directs access network 110 to support the data session. Access network 110 directs user device 101 to begin the session. The user application generates user data for the session. User device 101 routes the user data to the encrypted tunnel and wirelessly exchanges the user data with access network 110 in the encrypted tunnel. Access network 110 exchanges the user data in the encrypted tunnel with core network 120. Core network 120 exchanges the user data in the encrypted tunnel with external gateway 140 over data network 130.

Advantageously, user device 101 efficiently uses provisioned security credentials to establish an end-to-end encrypted tunnel over communication network 100 with an external gateway. Moreover, user device 101 effectively stores the security credentials in an isolated memory to inhibit the security credentials from being tampered with.

User device 101 may comprise a vehicle, drone, robot, computer, phone, sensor, or another type of data appliance with wireless and/or wireline communication circuitry. User device 101 and access network 110 may communicate over links using wireless/wireline technologies like Sixth Generation Radio (6GR), Fifth Generation New Radio (5GNR), Long Term Evolution (LTE), Institute of Electrical and Electronic Engineers (IEEE) 802.11 (WiFi), IEEE 802.3 (Ethernet), Low-Power Wide Area Network (LP-WAN), Bluetooth, and/or some other type of wireless and/or wireline networking protocol. The wireless technologies use electromagnetic frequencies in the low-band, mid-band, high-band, or some other portion of the electromagnetic spectrum. The wired connections comprise metallic links, glass fibers, and/or some other type of wired interface.

Although access network 110 is illustrated as comprising a tower, access network 110 may comprise another type of mounting structure (e.g., a building), or no mounting structure at all. Access network 110 may comprise a Sixth Generation (6G) Radio Access Network (RAN), Fifth Generation (5G) RAN, LTE RAN, gNodeB, eNodeB, Narrow Band Internet-of-Things (NB-IoT) access node, trusted non-Third Generation Partnership Project (3GPP) access node, untrusted non-3GPP access node, Low Power-Wide Area Network (LP-WAN) base station, wireless relay, WiFi hotspot, Bluetooth access node, Ethernet access node, and/or another type of wireless or wireline network transceiver. Access network 110 exchanges network signaling and user data with network functions clustered together into core network 120. Access network 110 is connected to core network 120 over one or more backhaul data links. Access network 110 and core network 120 may communicate via edge networks like internet backbone providers, edge computing systems, or another type of edge system to provide the backhaul data and signaling links between access network 110 and core network 120.

Access network 110 may comprise Radio Units (RUs), Distributed Units (DUs) and Centralized Units (CUs). The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to the network cores. The CUs handle higher wireless network layers like the Radio Resource Control (RRC), Service Data Adaption Protocol (SDAP), and Packet Data Convergence Protocol (PDCP). The CUs are coupled to network functions in core network 120.

Core network 120 is representative of computing systems that provide wireless data services to user device 101 over access network 110. Exemplary computing systems comprise Network Function Virtualization Infrastructure (NFVI) systems, data centers, server farms, cloud computing networks, hybrid cloud networks, and the like. Core network 120 may comprise a 3GPP core network architecture like Sixth Generation Core (6GC), Fifth Generation Core (5GC), Evolved Packet Core (EPC), and/or another type of 3GPP core network architecture. Access network 110 and core network 120 communicate over various links that use metallic links, glass fibers, radio channels, or some other communication media. The links use 6GC, 5GC, EPC, Ethernet, Time Division Multiplex (TDM), Data Over Cable System Interface Specification (DOCSIS), Internet Protocol (IP), General Packet Radio Service Transfer Protocol (GTP), 6GR, 5GNR, LTE, WiFi, virtual switching, inter-processor communication, bus interfaces, and/or some other data communication protocols. The computing systems of core network 120 store and execute the network functions/entities to form a control plane and a user plane. Exemplary control plane network functions include Access and Mobility Management Function (AMF), Session Management Function (SMF), Unified Data Management (UDM), Authentication Server Function (AUSF), Unified Data Registry (UDR), Policy Control Function (PCF), Mobility Management Entity (MME), Policy and Rules Charging Function (PCRF), Home Subscriber Server (HSS), and the like. Exemplary user plane network functions include User Plane Functions (UPF), Packet Gateway (P-GW), Serving Gateway (S-GW), and the like.

Data network 130 comprises an application servers, gateways, routers, and/or other communication devices to communicatively couple core network 120 and external gateway 140. Data network 130 may be representative of a public data network (e.g., the Internet) or a private data network (e.g., an enterprise network). External gateway 140 may comprise a security gateway, Virtual Private Network (VPN) gateway, or an application server. For example, external gateway 140 may be representative of an access point to an application server that hosts the server-side component of the user application executing on user device 101. Exemplary application types include media streaming applications, social media applications, IoT applications, online gaming applications, and the like. Core network 120, data network 130, and external gateway 140 may communicate via links provided by internet backbone providers, edge computing services, and/or other communication services that provide the data links between core network 120, data network 130, and external gateway 140.

User device 101 and access network 110 comprise antennas, amplifiers, filters, modulation, analog/digital interfaces, microprocessors, software, memories, transceivers, bus circuitry, and the like. User device 101, access network 110, core network 120, data network 130, and external gateway 140 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), Analog Processing Units (APUs), and/or the like. The memories comprise Random Access Memory (RAM), Solid State Drives (SSDs), Hard Disk Drives (HDDs), Non-Volatile Memory Express (NVMe) SSDs, and/or the like. The memories store software like operating systems, user applications, radio applications, and network functions. The microprocessors retrieve the software from the memories and execute the software to drive the operation of communication network 100 as described herein.

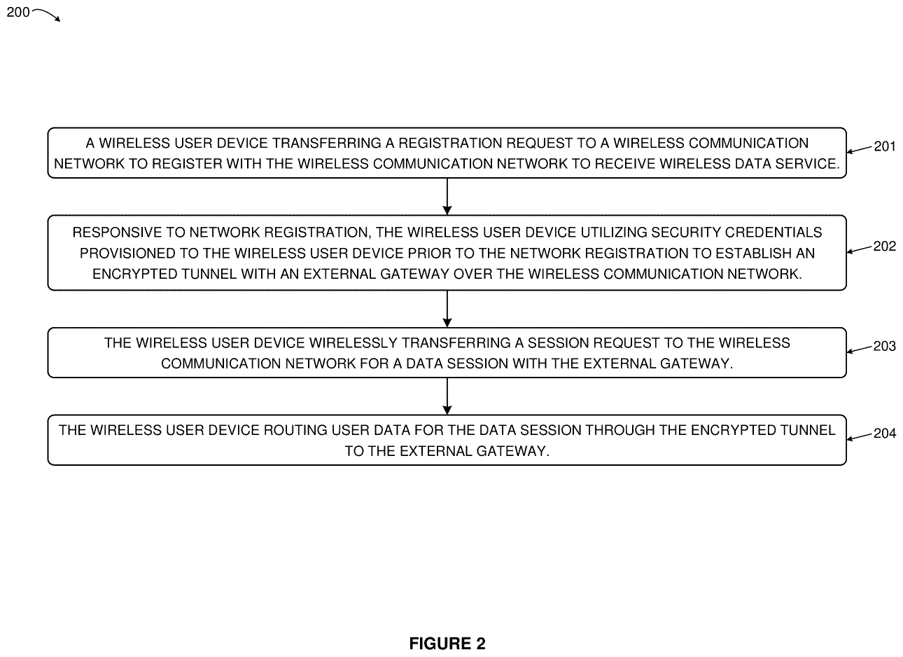

FIG. 2 illustrates process 200. Process 200 comprises an exemplary operation of communication network 100 to provide end-to-end security using wireless user device hardware layer encryption. Process 200 may vary in other examples. The operations of process 200 comprise a wireless user device transferring a registration request to a wireless communication network to register with the wireless communication network to receive wireless data service (step 201). The operations further comprise, responsive to network registration, the wireless user device utilizing security credentials provisioned to the wireless user device to establish an encrypted tunnel with an external gateway over the wireless communication network (step 202). The security credentials are stored in a memory in processing circuitry in the wireless user device and the memory in the processing circuitry is isolated from user circuitry in the wireless user device. The operations further comprise the wireless user device wirelessly transferring a session request to the wireless communication network for a data session with the external gateway (step 203). The operations further comprise the wireless user device routing user data for the data session through the encrypted tunnel to the external gateway (step 204). The user circuitry generates the user data for the data session and the processing circuitry routes the user data through the encrypted tunnel to the external gateway.

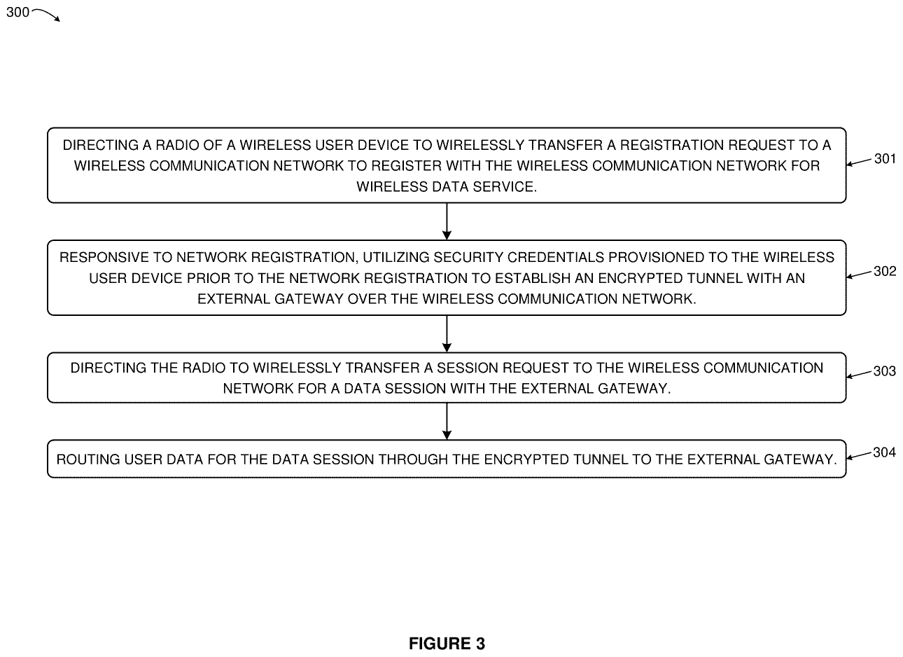

FIG. 3 illustrates process 300. Process 300 comprises an exemplary operation of communication network 100 to provide end-to-end security using wireless user device hardware layer encryption. Process 300 comprises an example of process 200 illustrated in FIG. 2, however process 200 may differ. Process 300 may vary in other examples. The operations of process 300 comprise directing a radio of a wireless user device to wirelessly transfer a registration request to a wireless communication network to register with the wireless communication network to receive wireless data service (step 301). The operations further comprise responsive to network registration, utilizing security credential provisioned to the wireless user device to establish an encrypted tunnel with an external gateway over the wireless communication network (step 302). T The security credentials are stored in a memory in processing circuitry in the wireless user device and the memory in the processing circuitry is isolated from user circuitry in the wireless user device. The operations further comprise directing the radio to wirelessly transfer a session request to the wireless communication network for a data session with the external gateway (step 303). The operations further comprise routing user data for the data session through the encrypted tunnel to the external gateway (step 304). The user circuitry generates the user data for the data session and the processing circuitry routes the user data through the encrypted tunnel to the external gateway.

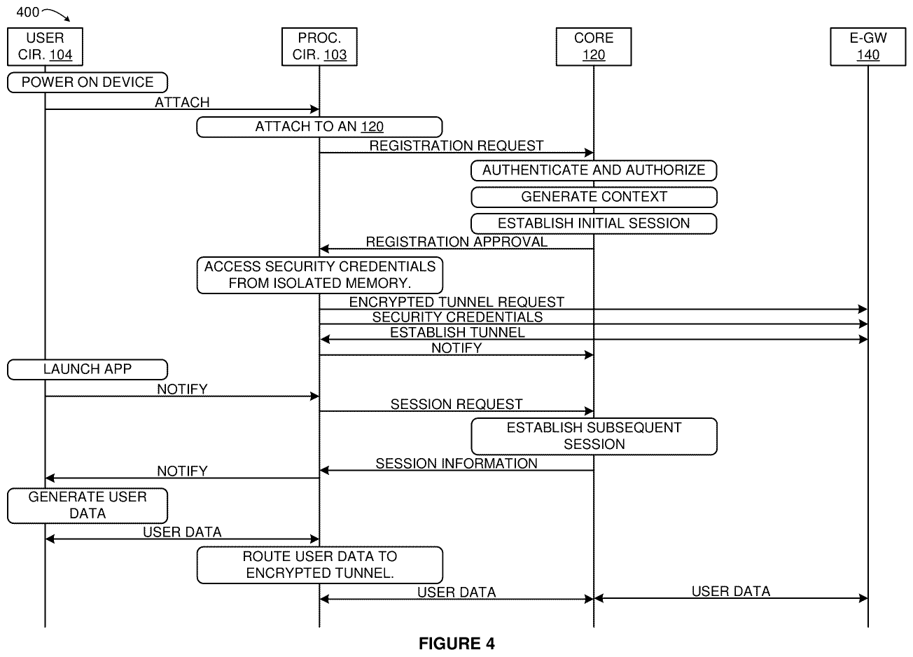

FIG. 4 illustrates process 400. Process 400 comprises an exemplary operation of communication network 100 to provide end-to-end security using wireless user device hardware layer encryption. Process 400 comprises an example of process 200 illustrated in FIG. 2 and process 300 illustrated in FIG. 3, however processes 200 and 300 may differ. Process 400 may vary in other examples. In some examples, user circuitry (CIR.) 104 receives a user input powering on user device 101 and directs processing circuitry (PROC. CIR.) 103 to attach to communication network 100. In response, processing circuitry 103 executes the network applications and controls radio circuitry 102 to wirelessly attach to access network 110. Processing circuitry 103 generates a registration request and controls radio circuitry 102 to wirelessly transfer the registration request to core network 120 over access network 110. The registration request includes information like subscriber ID, device capabilities, PDU session requests, and the like. Core network 120 authenticates user device 101 and authorizes user device 101 for wireless data service on communication network 100.

Responsive to authentication and authorization, core network 120 registers user device 101 for service on communication network 100. Core network 120 accesses a subscriber profile and generates context for user device 101. The context comprises subscriber attributes retrieved from the profile that define the level of service for user device 101. For example, the subscriber attributes may comprise Quality-of-Service (QoS) level, bitrate, latency, Data Network Name (DNN), and the like. In this example, the context indicates user device 101 is subscribed for end-to-end encryption of core network 120. Core network 120 establishes the links to support the initial session for user device 101 but does not begin buffering downlink data for the session based on user device 101's subscription for end-to-end encryption. Core network 120 directs access network 110 to serve user device 101 and transfers a registration accept message for user device 101 to processing circuitry 103. The registration accept message includes information like the context, network addresses, and/or other information for user device 101 to begin its data session.

Processing circuitry 103 receives the registration approval message. In response, processing circuitry 103 accesses the security credentials stored in an isolated memory of user device 101. Processing circuitry 103 generates an encrypted tunnel request that comprises the security credentials and controls radio circuitry 102 to transfer the encrypted tunnel request to core network 120 over access network 110. Core network 120 delivers the request to external gateway (E-GW) 140 over data network 130. External gateway 140 receives the request and establishes an encrypted tunnel with user device 101 based on the security credentials. For example, the security credentials may comprise a signed certificate identifying user device 101, information that identifies the encryption protocol for end-to-end encryption of the data session, and information the identifies the key to use for data encryption/decryption. External gateway 140 may then establish the encrypted tunnel based on the signed certificate, the encryption protocol, and the encryption/decryption keys. As such, user device 101 and external gateway 140 avoid having to undergo a handshake procedure to identify user device 101, authorize user device 101, and select an encryption method thereby reducing the risk of sensitive data exposure. Processing circuitry 103 control radio circuitry 102 to notify core network 120 that user device 101's encrypted tunnel is set up.

User circuitry 104 receives a user input launching one of the user applications and notifies processing circuitry 103. Processing circuitry 103 generates a session request for a wireless data session for the user application. Radio circuitry 102 wirelessly transfers the session request to access network 110 which forwards the request to core network 120. Core network 120 organizes hardware and software resources to support the data session in the encrypted tunnel. Core network 120 directs access network 110 to support the data session and transfers session information (e.g., network addresses, bitrates, slice IDs, etc.) for the session to processing circuitry 103 over access network 110 and radio circuitry 102. The user application executing in user circuitry 104 generates user data for the session. Processing circuitry 103 encrypts the user data and controls radio circuitry 102 to wirelessly exchange the encrypted user data with access network 110 in the end-to-end tunnel. Access network 110 exchanges the encrypted user data in the end-to-end tunnel with core network 120. Core network 120 exchanges the encrypted user data in the end-to-end tunnel with external gateway 140 over data network 130. While user circuitry 104 is described as launching the user applications in response to user input, in some examples, user circuitry 104 may launch user applications automatically (i.e., without receiving user input) when user device 101 powers on. For example, applications like weather applications and email applications may launch automatically. The automatically launched applications typically attempt to connect to the internet over communication network 100 when user device 101 powers on. Processing circuitry 103 inhibits these applications from beginning data sessions until the end-to-end encrypted tunnel to external gateway 140 is created.

In some examples, core network 120 may transfer a provisioning update to user processing circuitry 103 over access network 110 and radio circuitry 102 to update the security credentials. For example, the provisioning update may include a new encryption key selected by external gateway 140 for user device 101 to use to establish subsequent end-to-end encrypted tunnels. Radio circuitry 102 wirelessly receives the provisioning update and provides the update to processing circuitry 103. Processing circuitry 103 writes an update to the isolated memory to modify the security credentials stored in the isolated memory using the information received in the provisioning update. Processing circuitry 103 uses the updated security credentials to establish subsequent end-to-end encrypted tunnels with external gateway 140.

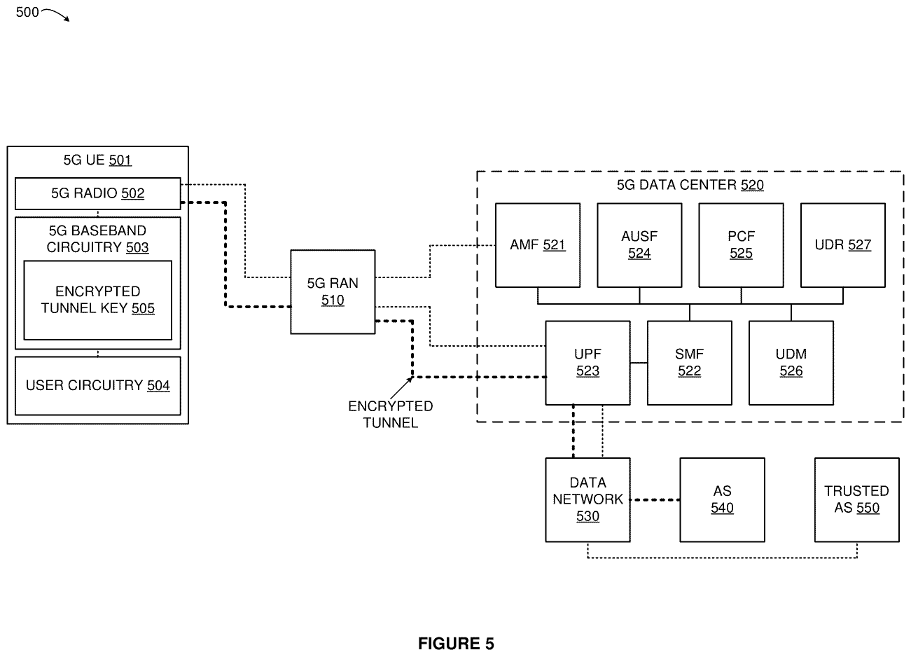

FIG. 5 illustrates 5G communication network 500 to provide end-to-end security using User Equipment (UE) hardware layer encryption. 5G communication network 500 comprises an example of communication network 100 illustrated in FIG. 1, however communication network 100 may differ. 5G communication network 500 comprises 5G UE 501, 5G RAN 510, 5G data center 520, data network 530, application server (AS) 540, and trusted application server 550. 5G UE 501 comprises 5G radio 502, 5G baseband circuitry 503, user circuitry 504. 5G baseband circuitry 503 stores encrypted tunnel key 505. 5G data center 520 comprises AMF 521, SMF 522, UPF 523, AUSF 524, PCF 525, UDM 526, and UDR 527. Other network functions and network entities like Network Slice Selection Function (NSSF), Charging Function (CHF), Home Subscriber Register (HLR), HSS, Network Repository Function (NRF), Short Message Service Function (SMSF), Network Exposure Function (NEF), Application Function (AF), Equipment Identity Register (EIR), and Session Communication Proxy (SCP) are typically present in 5G network data center 520 but are omitted for clarity. In other examples, 5G communication network 500 may comprise different or additional elements than those illustrated in FIG. 5.

In some examples, user circuitry 504 receives a user input powering on 5G UE 501 and directs 5G baseband circuitry 503 to attach to a wireless network. 5G baseband circuitry 503 controls 5G radio 502 to receive a synchronization signal broadcast by 5G RAN 510. 5G baseband circuitry 503 determines the Received Signal Received Power (RSRP) and/or Received Signal Received Quality (RSRQ) of the synchronization signal to is sufficient and decides to attach. 5G baseband circuitry 503 transfers a random preamble to 5G RAN 510 over 5G radio 502 initiating a Random Access Channel (RACH) procedure to establish a secure signaling channel. 5G RAN 510 and 5G UE 501 complete the RACH procedure and 5G baseband circuitry 503 establishes an RRC connection with 5G RAN 510 over 5G radio 502. 5G baseband circuitry 503 generates a registration request. The registration request indicates a registration type, 5G-Global Unique Temporary Identifier (GUTI), Tracking Area Identifier (TAI), Network Slice Selection Assistance Information (NSSAI) requests, UE capabilities, PDU session requests, and the like. 5G baseband circuitry 503 includes an encrypted tunnel request in the registration request. The encrypted tunnel request comprises a signed certificate authorizing UE 501 for end-to-end encryption, identifies the encryption/decryption protocol for the end-to-end tunnel, and identifies the keys to use for encryption/decryption. 5G baseband circuitry 503 transfers the registration request to AMF 521 over 5G radio 502 and 5G RAN 510.

In response to the registration request, AMF 521 transfers a Non-Access Stratum (NAS) identity request to 5G baseband circuitry 503 over 5G RAN 510 and 5G radio 502. 5G baseband circuitry 503 indicates the Subscriber Concealed Identifier (SUCI) of 5G UE 501 to AMF 521 over 5G radio 502 and 5G RAN 510. AMF 521 transfers an authentication request that includes the SUCI to AUSF 524. AUSF 524 indicates the SUCI to UDM 526 and requests authentication vectors for UE 501 from UDM 526. UDM 526 returns authentication vectors and the Subscriber Permanent Identifier (SUPI) for UE 501 to AUSF 524. The authentication vectors comprise a random number, expected result, key selection criteria, and the like. AUSF 524 forwards the SUPI and authentication vectors to AMF 521. AMF 521 transfers an authentication challenge that comprises the random number and key selection criteria to 5G baseband circuitry 503 over 5G RAN 510 and 5G radio 502. 5G baseband circuitry 503 hashes random number with its secret key to generate an authentication result and indicates the authentication result to AMF 521 over 5G radio 502 and 5G RAN 510. AMF 521 matches the expected result with the authentication result to authenticate UE 501.

Responsive to the authentication, AMF 521 transfers a context registration request to UDM 526 that includes AMF ID, a supported feature list, a Permanent Equipment Identifier (PEI) for UE 501, and the like. UDM 526 indicates successful UDM registration to AMF 521. In response, AMF 521 requests access and mobility subscription data, SMS selection subscription data, and UE context in SMF data from UDM 526. UDM 526 accesses the subscriber profile for UE 501 stored by UDR 527. The access and mobility subscription data comprises a supported feature list for UE 501 (e.g., Quality of Service Class Indicator (QCI), Aggregate Maximum Bit Rate (AMBR), latency, voice/video calling, internet access, etc.), a General Public Subscription Identifier (GPSI) array, slice selection information, and the like. The SMF selection data comprises a supported feature list, and a list of allowed S-NSSAIs and associated information. The UE context in SMF data comprises PDU session and EPC interworking information. The access and mobility subscription data, SMS selection subscription data, and/or UE context in SMF data indicates 5G UE 501 is subscribed for end-to-end hardware layer encryption. For example, UDM 526 may retrieve a network code for end-to-end hardware layer encryption from 5G UE 501's subscriber profile stored by UDR 527. UDM 526 returns the requested data to AMF 521. AMF 521 forms the UE context for 5G UE 501 using the retrieved information. The UE context defines the authorized services for 5G UE 501.

AMF 521 transfers a policy creation request to PCF 525 to create a policy association for UE 501. PCF 525 responds to the request with policy association information like the SUPI, GPSI, PEI, and user location information for 5G UE 501. The policy association information may include network rules that direct AMF 521, SMF 522, and UPF 523 to postpone data transfer for 5G UE 501 until an end-to-end encrypted tunnel is created for 5G UE 501. PCF 525 subscribes to AMF 521 for event reporting like user location updates, registration state changes, communication failure events, and the like. AMF 521 creates a PCF subscription based on the policy association information and signals PCF 525 of the successful subscription creation.

In some examples, AMF 521 may interface with other network functions in 5G data center 520 to select one or more network slices for 5G UE 501. Wireless network slices typically comprise collections of core network and RAN resources that have capabilities to provide service types (e.g., low-latency service) to UEs. Exemplary slice types include Enhanced Mobile Broadband (eMBB), Massive Internet-of-Things (MIoT), and Ultra-Reliable Low-Latency Communications (URLLC). For example, AMF 521 may interface with an NSSF to select a network slice with capabilities to support end-to-end encryption for 5G UE 501.

AMF 521 selects SMF 522 to serve UE 501 based on SMF selection data received from UDM 526, the network policies received from PCF 525, and/or the network slice(s) selected for 5G UE 501. AMF 521 transfers a list of requested PDU sessions with enterprise network 541 and/or data network 542 (as received during the registration request), a PDU session activation command, and the SUPI (that includes UE 501's IMSI) to SMF 522. AMF 521 transfers the end-to-end encryption request for UE 501 included in UE 501's registration request to SMF 522 to indicate that 5G UE 501 is subscribed for end-to-end encryption with external application servers over 5G communication network 500.

SMF 522 receives the PDU session list, session activation command, the SUPI, and end-to-end encryption request from AMF 521. SMF 522 allocates IP addresses to UE 501 for the requested PDU sessions and allocates a TEID for the session. SMF 522 selects UPF 523 to serve UE 501. SMF 522 transfers a session modification request that includes a session endpoint identifier and TEID to UPF 523 to set up the PDU sessions for UE 501. UPF 523 sets up a default bearer for UE 501 with 5G RAN 510. The default bearer is a link to carry IP packets for UE 501's PDU session. UPF 523 transfers a session modification response to SMF 522 that includes the session endpoint identifier to confirm bearer setup. SMF 522 controls UPF 523 to prevent user data exchange until end-to-end encryption is set up for 5G UE 501. SMF 522 transfers the end-to-end encryption request to application server 540.

Application server 540 receives the end-to-end encryption request for UE 501. Application server 540 accepts the request based on the signed certificate authorizing UE 501 for end-to-end encryption included in the request. Application server 540 selects a key for encryption/decryption based on the encryption/decryption protocol indication (e.g., a TLS indication) and key indication included in the request. The cryptography keys used by 5G UE 501 and application server 540 may comprise symmetric keys, asymmetric keys, public private key pairs, and the like. Application server 540 transfers an encrypted tunnel notification to SMF 522 to indicate that the end-to-end encrypted tunnel is ready. As illustrated in FIG. 5, the end-to-end encrypted tunnel traverses 5G RAN 510, UPF 523, and data network 530 to communicatively couple 5G radio 502 and application server 540.

SMF 522 receives the notification from application server 540 and in response, returns a PDU session create response to AMF 521 to confirm session creation. The response includes session context (e.g., allocated IP addresses, TEID, etc.) and the encrypted tunnel notification. In response, AMF 521 registers UE 501 for service on 5G communication network 500. AMF 521 generates a registration accept message that includes the allocated UE IP address, RAN ID, AMBR, Globally Unique AMF ID (GUAMI), PDU session ID, PDU session TEID, allowed NSSAI list, security data, the encrypted tunnel notification, and the like. AMF 521 transfers the registration accept message to 5G RAN 510 to direct RAN 510 to serve UE 501.

5G RAN 510 schedules uplink and downlink resource blocks for UE 501 to assign time and frequency domain resources for the PDU session based on the registration accept message. 5G RAN 510 transfers an RRC reconfiguration message to 5G baseband circuitry 503 over 5G radio 502 to setup data radio bearers. The message includes cell IDs, bearer configuration information, the encrypted tunnel notification, and/or other session information received from AMF 521. 5G baseband circuitry 503 configures the data radio bearers using the received information. 5G baseband circuitry 503 notifies user circuitry 504 that the end-to-end encrypted tunnel is ready and that subsequent PDU sessions may begin.

User circuitry 504 receives a user input launching one or more of user applications A-C and in response, notifies 5G baseband circuitry 503. Alternatively, user circuitry 504 may launch one or more of user applications A-C automatically when 5G UE 501 powers on. 5G baseband circuitry 503 generates and transfers a PDU session request for the user application to AMF 521 over 5G radio 502 and 5G RAN 510. AMF 521 transfers PDU session create request to SMF 522. SMF 522 allocates IP addresses and TEID for the requested session. SMF 522 selects UPF 523 to support the PDU session and transfers a session modification response to UPF 523 to create bearers for the PDU session. UPF 523 transfers a session modification response to SMF 522 to confirm bearer creation. SMF 522 controls UPF 523 to route user data for the PDU session through the end-to-end encrypted tunnel between UE 501 and application server 540. SMF 522 notifies AMF 521 that the PDU session is ready to begin. AMF 521 directs 5G RAN 510 to serve UE 501 and directs 5G baseband circuitry 503 to begin the session over 5G RAN 510 and 5G radio 502. 5G baseband circuitry 503 notifies user circuitry that the PDU session is ready.

The user application executing in user circuitry 504 generates uplink user data for the session. User circuitry 504 provides the uplink user data to 5G baseband circuitry 503. 5G baseband circuitry 503 retrieves encrypted tunnel key 505 and encrypts the uplink user data. 5G baseband circuitry 503 controls 5G radio 502 to transfer the encrypted uplink user data to UPF 523 over 5G RAN 510. UPF 523 transfers the encrypted uplink user data to application server 540 in the encrypted tunnel that traverses data network 530. Application server 540 receives the encrypted uplink data and decrypts the data using a local copy of encrypted tunnel key 505. Application server 540 generates downlink data and encrypts the downlink data using the local copy of encrypted tunnel key 505. Application server 540 transfers the encrypted downlink data to UPF 523 in the encrypted tunnel that traverses data network 530. UPF 523 transfers the encrypted downlink user data to baseband circuitry 503 over 5G RAN 510 and 5G radio 502. 5G baseband circuitry 503 decrypts the encrypted downlink data using encrypted tunnel key 505.

In some examples, 5G UE 501 may receive an over-the-air provisioning update to update encrypted tunnel key 505. For example, application server 540 may select a new key to be used for future end-to-end encrypted communication with 5G UE 501. Application server 540 may transfer a provisioning request that includes the updated key to SMF 522 (or another network provisioning entity) over data network 530 and UPF 523. SMF 522 in turn reports the provisioning request to AMF 521. AMF 521 generates a provisioning update that includes the new key and transfers provisioning update to 5G baseband circuitry 503 over 5G RAN 510 and 5G radio 502. 5G baseband circuitry 503 stores the new key in the isolated memory to replace encrypted tunnel key 505. 5G baseband circuitry 503 may transfer a new encrypted tunnel request towards application server 540 (e.g., over RAN 510 and UPF 523) to reestablish the end-to-end encrypted tunnel. The new encrypted tunnel request may include the signed certificate, identify the encryption protocol, and indicate the newly provisioned key.

In some examples, 5G UE 501 may route user data for PDU sessions with trusted endpoints outside of the encrypted tunnel. For example, one of user applications A-C may be associated with trusted application server 550. User circuity 504 executes this application and notifies 5G baseband circuitry 503. 5G baseband circuitry 503 transfers a PDU session request to AMF 521 that indicates trusted application server 550. For example, the request may include a DNN associated with trusted application server 550. AMF 521 receives the request and directs SMF 522 to create the PDU session. SMF 522 selects IP addresses and a TEID for the session and directs UPF 523 to create bearers for the session. Since the PDU session is associated with a trusted endpoint, SMF 522 does not control UPF 523 to route user data for the session through the end-to-end encrypted tunnel. SMF 522 notifies AMF 521 that the PDU session is ready. AMF 521 directs 5G baseband circuitry 503 to begin the session over 5G RAN 510 and 5G radio 502. The user application associated with trusted application server 550 executing in user circuitry 504 generates user data for the PDU session. 5G baseband circuitry 503 exchanges the user data with UPF 523 over 5G radio 502 and 5G RAN 510 outside of the encrypted tunnel. 5G baseband circuitry 503 does not encrypt the user data since the PDU session endpoint is trusted. UPF 523 exchanges the user data with trusted application server 550 outside of the encrypted tunnel over data network 530.

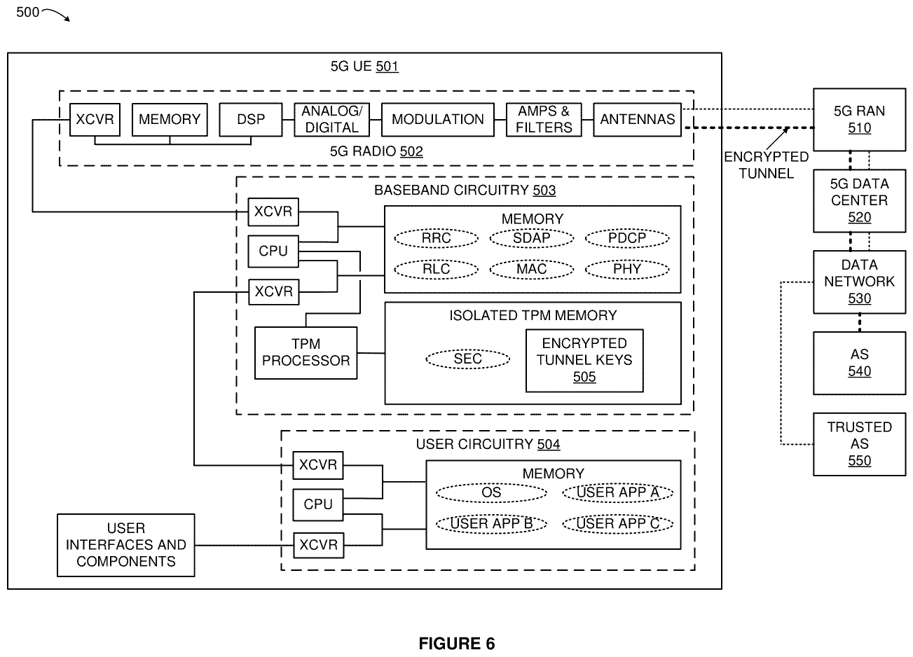

FIG. 6 illustrates 5G UE 501 in 5G communication network 500. 5G UE 501 comprises an example of user device 101 illustrated in FIG. 1, although user device 101 may differ. UE 501 comprises 5G radio 502, baseband circuitry 503, and user circuitry 504. 5G radio 502 comprises 5GNR antennas, amplifiers, filters, modulation, analog-to-digital interfaces, Digital Signal Processers (DSP), memory, and transceivers (XCVRs) that are coupled over bus circuitry. Baseband circuitry 503 comprises memory, CPU, a Trusted Platform Module (TPM) processor, isolated TPM memory, and transceivers that are coupled over bus circuitry. User circuitry 504 comprises memory, CPU, user interfaces and components, and transceivers that are coupled over bus circuitry. The memory in baseband circuitry 503 stores 5GNR network applications for PHY, MAC, RLC, PDCP, SDAP, and RRC. The isolated TPM memory in baseband circuitry 503 stores a Security Application (SEC) and encrypted tunnel key 505. The memory in user circuitry 504 stores an operating system (OS) and user applications A, B, and C.

The antenna in 5G radio 502 is wirelessly coupled to 5G RAN 510 over a 5GNR link. A transceiver in radio 502 is coupled to a transceiver in baseband circuitry 503. A transceiver in baseband circuitry 503 is coupled to a transceiver in user circuitry 504. A transceiver in user circuitry 504 is typically coupled to user interfaces and components like displays, controllers, and memory. The isolated TPM memory in baseband circuitry 503 is isolated from user circuitry 504. As such, the operating system and user applications in the memory of user circuitry 504 cannot tamper with or otherwise access encrypted tunnel key 505. This isolation inhibits the user of 5G UE 501 from accessing encrypted tunnel key 505 which increases the immutability of encrypted tunnel key 505.

In 5G radio 502, the antennas receive wireless signals from 5G RAN 510 that transport downlink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the DSPs. The DSPs transfer corresponding 5GNR symbols to baseband circuitry 503 over the transceivers. In baseband circuitry 503, the CPU executes the network applications to process the 5GNR symbols and recover the downlink 5GNR signaling and data. The 5GNR network applications receive new uplink signaling and data from the user applications executing in user circuitry 504. The network applications process the uplink user signaling and the downlink 5GNR signaling to generate new downlink user signaling and new uplink 5GNR signaling. The network applications transfer the new downlink user signaling and data to the user applications. The 5GNR network applications process the new uplink 5GNR signaling and user data to generate corresponding uplink 5GNR symbols that carry the uplink 5GNR signaling and data.

In 5G radio 502, the DSP processes the uplink 5GNR symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless 5GNR signals to 5G RAN 510 that transport the uplink 5GNR signaling and data.

RRC functions comprise authentication, security, handover control, status reporting, QoS, network broadcasts and pages, and network selection. SDAP functions comprise QoS marking and flow control. PDCP functions comprise security ciphering, header compression and decompression, sequence numbering and re-sequencing, de-duplication. RLC functions comprise Automatic Repeat Request (ARQ), sequence numbering and resequencing, segmentation and resegmentation. MAC functions comprise buffer status, power control, channel quality, Hybrid ARQ (HARQ), user identification, random access, user scheduling, and QoS. PHY functions comprise packet formation/deformation, windowing/de-windowing, guard-insertion/guard-deletion, parsing/de-parsing, control insertion/removal, interleaving/de-interleaving, Forward Error Correction (FEC) encoding/decoding, channel coding/decoding, channel estimation/equalization, and rate matching/de-matching, scrambling/descrambling, modulation mapping/de-mapping, layer mapping/de-mapping, precoding, Resource Element (RE) mapping/de-mapping, Fast Fourier Transforms (FFTs)/Inverse FFTs (IFFTs), and Discrete Fourier Transforms (DFTs)/Inverse DFTs (IDFTs). SEC functions comprise encrypted tunnel request generation, encrypted tunnel establishment, data encryption/decryption, key management, and key selection.

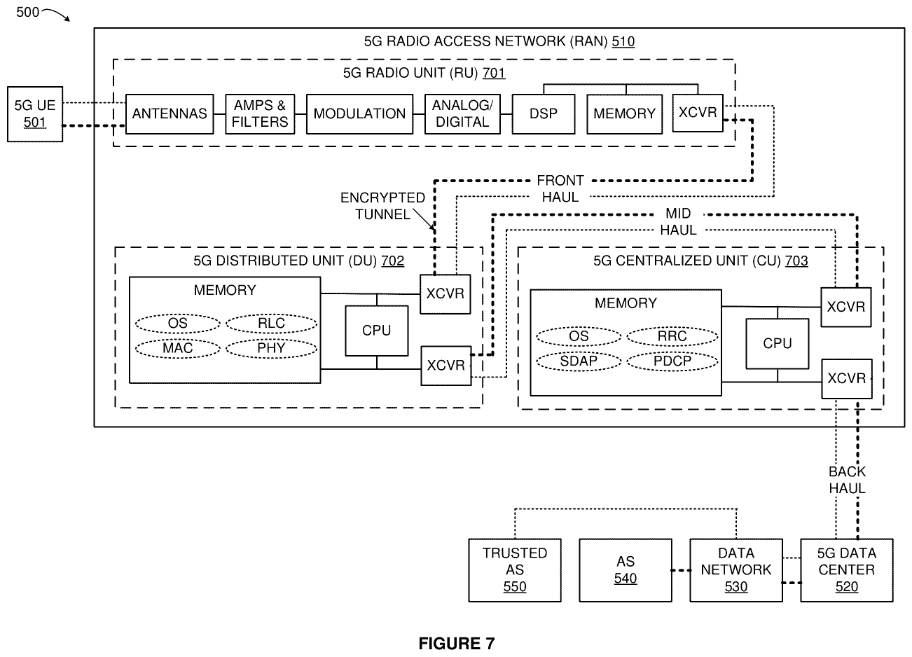

FIG. 7 illustrates 5G RAN 510 in 5G communication network 500. 5G RAN 510 comprises an example of the access network 110 illustrated in FIG. 1, although access network 110 may differ. RU 701 comprises 5GNR antennas, amplifiers, filters, modulation, analog-to-digital interfaces, DSP, memory, and transceivers (XCVRs) that are coupled over bus circuitry. UE 501 is wirelessly coupled to antennas in RU 701 over 5GNR links. Transceivers in RU 701 are coupled to transceivers in DU 702 over fronthaul links like enhanced Common Public Radio Interface (eCPRI). The DSPs in RU 701 executes their operating systems and radio applications to exchange 5GNR signals with UE 501 and to exchange 5GNR data with DU 702.

For the uplink, the antennas in RU 701 receive wireless signals from UE 501 that transport uplink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding 5GNR symbols to DU 702 over the transceivers.

For the downlink, the DSPs receive downlink 5GNR symbols from DU 702. The DSPs process the downlink 5GNR symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to UE 501 that transport the downlink 5GNR signaling and data.

DU 702 comprises memory, CPU, and transceivers that are coupled over bus circuitry. The memory in DU 702 stores operating systems and 5GNR network applications like PHY, MAC, and RLC. CU 703 comprises memory, CPU, and transceivers that are coupled over bus circuitry. The memory in CU 703 stores an operating system, 5GNR network applications like PDCP, SDAP, and RRC, and a machine learning model. Transceivers in DU 702 are coupled to transceivers in RU 701 over front-haul links. Transceivers in DU 702 are coupled to transceivers in CU 703 over mid-haul links.

RLC functions comprise ARQ, sequence numbering and resequencing, segmentation and resegmentation. MAC functions comprise buffer status, power control, channel quality, HARQ, user identification, random access, user scheduling, and QoS. PHY functions comprise packet formation/deformation, guard-insertion/guard-deletion, parsing/de-parsing, control insertion/removal, interleaving/de-interleaving, FEC encoding/decoding, channel coding/decoding, channel estimation/equalization, and rate matching/de-matching, scrambling/descrambling, modulation mapping/de-mapping, layer mapping/de-mapping, precoding, RE mapping/de-mapping, FFTs/IFFTs, and DFTs/IDFTs. PDCP functions include security ciphering, header compression and decompression, sequence numbering and re-sequencing, de-duplication. SDAP functions include QoS marking and flow control. RRC functions include authentication, security, handover control, status reporting, QoS, network broadcasts and pages, and network selection.

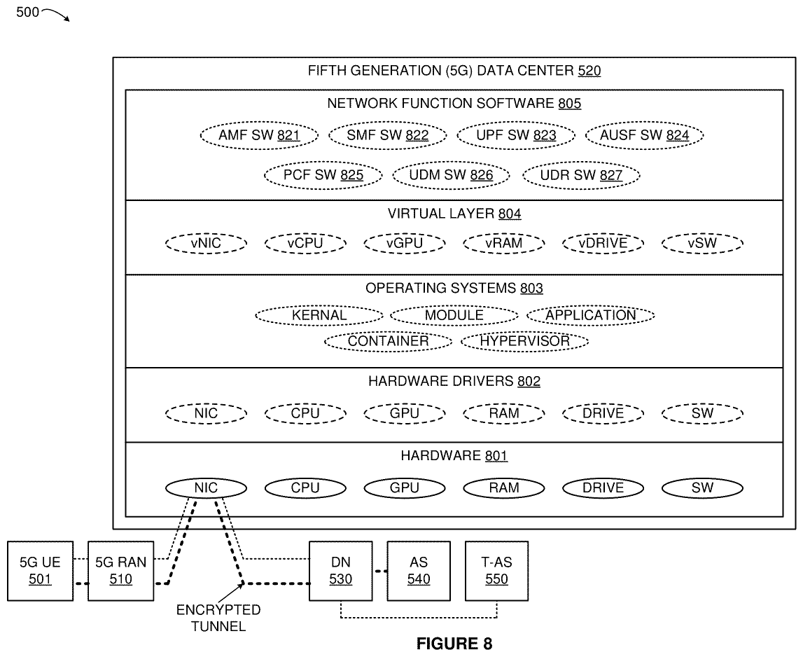

FIG. 8 illustrates 5G data center 520 in 5G communication network 500. 5G data center 520 comprises an example of core network 120 illustrated in FIG. 1, although core network 120 may differ. 5G data center 520 typically comprises a virtualized computing architecture like NFVI, but may comprise another computing architecture like a cloud computing network, a hybrid cloud network, and the like. 5G data center 520 comprises hardware 801, hardware drivers 802, operating systems 803, virtual layer 804, and network function software 805. Hardware 801 comprises Network Interface Cards (NICs), CPU, GPU, RAM, Flash/Disk Drives (DRIVE), and Data Switches (SW). Hardware drivers 802 comprise software that is resident in the NIC, CPU, GPU, RAM, DRIVE, and SW. Operating systems 803 comprise kernels, modules, applications, containers, hypervisors, and the like. Virtual layer 804 comprises vNIC, vCPU, vGPU, vRAM, vDRIVE, and vSW. Network function software 805 comprises AMF Software (SW) 821, SMF SW 822, UPF SW 823, AUSF SW 824, PCF SW 825, UDM SW 826, and UDR SW 827. Additional network function software for network functions like NSSF, CHF, HLR, HSS, NRF, SMSF, NEF, AF, EIR, and SCP is typically present but is omitted for clarity. 5G data center 520 may be located at a single site or be distributed across multiple geographic locations. The NIC in hardware 801 is coupled to 5G RAN 510, data network 530, and to external systems (not illustrated). Hardware 801 executes hardware drivers 802, operating systems 803, virtual layer 804, and network function software 805 to form AMF 521, SMF 522, UPF 523, AUSF 524, PCF 525, UDM 526, and UDR 527.

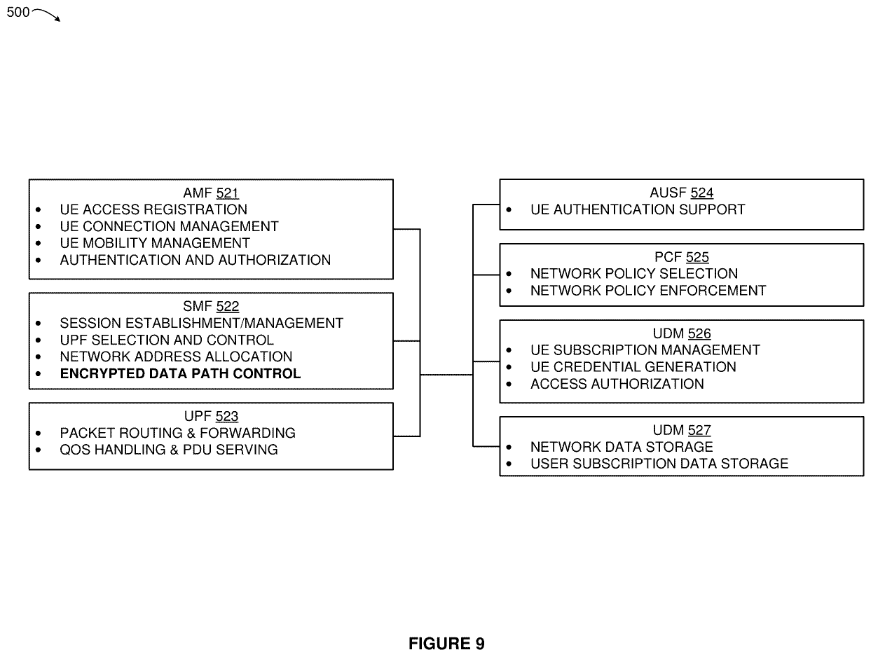

FIG. 9 further illustrates 5G data center 520 in 5G communication network 500. AMF 521 capabilities comprise UE access registration, UE connection management, UE mobility management, UE authentication, and UE authorization. SMF 522 capabilities comprise session establishment, session management, UPF selection, UPF control, network address allocation, and encrypted data path control. UPF 523 capabilities comprise pack routing, packet forwarding, QoS handling, and PDU serving. AUSF 524 capabilities comprise UE authentication support. PCF 525 capabilities comprise network policy selection and network policy enforcement. UDM 526 capabilities comprise UE subscription management, UE credential generation, and UE access authorization. UDM 527 capabilities comprise network data storage and user subscription data storage.

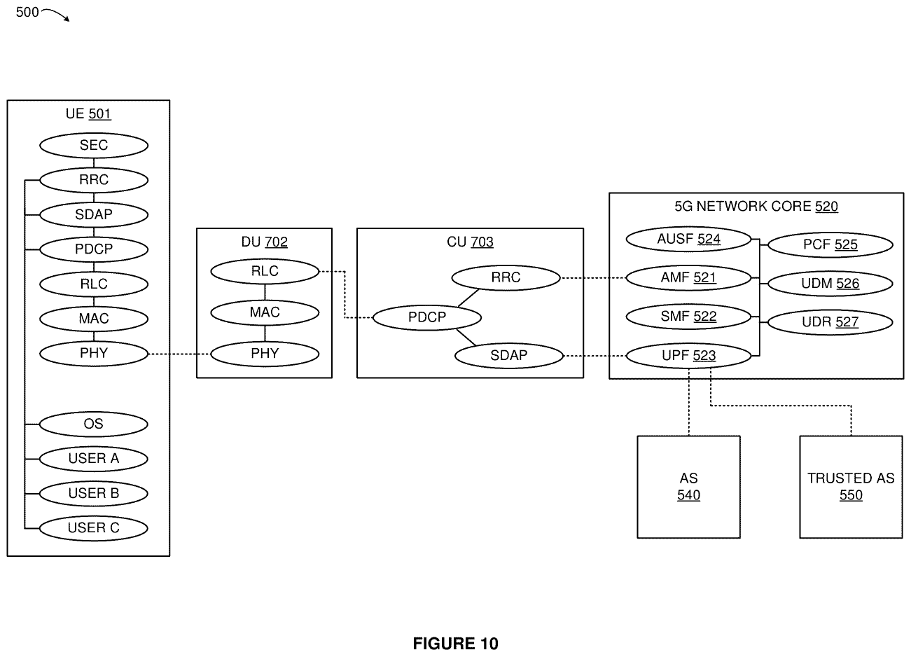

FIG. 10 illustrates an exemplary operation of 5G communication network 500 to provide end-to-end security using UE hardware layer encryption. The exemplary operation comprises an example of processes 200, 300, and 400 illustrated in FIGS. 2-4, however processes 200, 300, and 400 may differ. The exemplary operation may vary in other examples. In some examples, 5G UE 501 powers on and attaches to 5G RAN 510. The RRC in 5G UE 501 transfers a registration request to the RRC in CU 703 over the PDCPs, RLCs, MACs, and PHYs. The registration request includes an encrypted tunnel request. The encrypted tunnel request comprises UE 501's signed certificate authorizing end-to-end encryption, identifies an encryption protocol for the end-to-end encrypted tunnel, and identifies the keys to use for encryption/decryption. The RRC in CU 703 forwards the registration request to AMF 521. AMF 521 interfaces with AUSF 524 and UDM 526 to authenticate 5G UE 501. Responsive to authentication, AMF 521 requests UE context from UDM 526. UDM 526 accesses a subscriber profile for UE 501 stored by UDR 527 and retrieves network attributes that define UE 501's level of service on 5G communication network 500. The network attributes indicate UE 501 is subscribed for end-to-end hardware layer encryption. UDM 526 returns the network attributes to AMF 521. AMF 521 creates the UE context for 5G UE 501 using the network attributes. AMF 521 requests network policies for UE 501 from PCF 525. PCF 525 returns network policies that direct AMF 521, SMF 522, and UPF 523 to postpone data transfer for 5G UE 501 until an end-to-end encrypted tunnel is established for 5G UE 501.

AMF 521 directs SMF 522 to serve UE 501. AMF 521 transfers the end-to-end encryption request for UE 501 included in UE 501's registration request to SMF 522 to indicate that 5G UE 501 is subscribed for end-to-end encryption with application servers 540. SMF 522 allocates network addresses for the PDU session and selects UPF 523 to serve UE 501. SMF 522 directs UPF 523 to support the PDU session for UE 501. SMF 522 controls UPF 523 to prevent user data exchange until end-to-end encryption is set up for 5G UE 501. SMF 522 transfers the end-to-end encryption request to application server 540. Application server 540 receives the end-to-end encryption request for UE 501. Application server 540 authorizes UE 501 for end-to-end encryption based on the signed certificate included in the request. Application server 540 selects a key for encryption based on the encryption protocol and key indication included in the request. Application server 540 notifies SMF 522 that the end-to-end encrypted tunnel between UE 501 and application server 540 is established.

SMF 522 notifies AMF 521 that the PDU session is ready and that the end-to-end encrypted tunnel between UE 501 and application server 540 is established. In response, AMF 521 registers UE 501 for wireless service. AMF 521 directs the RRC in CU 703 to serve UE 501. AMF 521 transfers a registration accept message that includes the UE context and indicates the end-to-end encrypted tunnel is ready to the RRC. The RRC transfers the registration accept message to the RRC in UE 501 over the PDCPs, RLCs, MACs, and PHYs.

Subsequently, 5G UE 501 receives a user input launching one of user applications A-C. The RRC in UE 501 transfers a PDU session request for the user application to the RRC in CU 703 over the PDCPs, RLCs, MACs, and PHYs. The RRC in CU 703 forwards the request to AMF 521. AMF 521 directs SMF 522 to set up the requested PDU session. SMF 522 controls UPF 523 to route user data for the PDU session through the end-to-end encrypted tunnel between UE 501 and application server 540. In doing so, SMF 522 encapsulates a subsequent PDU session into the initial PDU session that comprises the end-to-end encrypted tunnel between 5G UE 501 and application server 540. SMF 522 notifies AMF 521 that the PDU session is ready, and AMF 521 directs the RRC in CU 703 to serve UE 501. In response, the RRC in CU 703 notifies the RRC in UE 501 that the session may begin over the PDCPs, RLCs, MACs, and PHYs.

The user application executing in user circuitry 504 generates uplink user data for the session. The user application provides the uplink user data to the SDAP in UE 501. The SEC in UE 501 retrieves encrypted tunnel key 505 from the isolated memory and encrypts the uplink user data. The SDAP transfers the encrypted uplink user data to the SDAP in CU 703 over the PDCPs, RLCs, MACs, and PHYs. The SDAP in CU 703 transfers the encrypted uplink user data to UPF 523. UPF 523 transfers the encrypted uplink user data to application server 540. Application server 540 receives the encrypted uplink data and decrypts the data using a local copy of encrypted tunnel key 505. Application server 540 generates downlink data and encrypts the downlink data using the local copy of encrypted tunnel key 505. Application server 540 transfers the encrypted downlink data to UPF 523. UPF 523 transfers the encrypted downlink user data to the SDAP in CU 703. The SDAP in CU 703 transfers the encrypted downlink user data to the SDAP in UE 501 over the PDCPs, RLCs, MACs, and PHYs. The SEC in UE 501 decrypts the encrypted downlink data using encrypted tunnel key 505.

The wireless data network circuitry described above comprises computer hardware and software that form special-purpose network circuitry to provide end-to-end security using wireless user device hardware layer encryption. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to provide end-to-end security using wireless user device hardware layer encryption.

Although the descriptions provided herein may be in the context of certain radio access technologies, networks, and network topologies, such as 5GNR mobile communications, the proposed concepts, schemes, and any variations thereof may be implemented in, for and by other types of radio access technologies, networks, and network topologies. Such radio access technologies, networks, and network topologies may include, for example and without limitation, LTE, Internet-of-Things (IoT), NB-IoT, Vehicle-to-Everything (V2X), fixed wireless internet, and Non-Terrestrial Network (NTN) communications. Thus, the scope of the disclosure is not limited to the examples described herein.

The above description and associated figures teach the best mode of the invention. For the purpose of teaching inventive principles, some conventional aspects of the best mode may be simplified or omitted. The following claims specify the scope of the invention. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described above, nor the best mode, but only by the claims and their equivalents.

What is claimed is:

1. A method comprising:
wirelessly transferring, by a wireless user device, a registration request to a wireless communication network to register with the wireless communication network for wireless data service;
responsive to network registration, utilizing, by the wireless user device, security credentials provisioned to the wireless user device prior to the network registration to establish an encrypted tunnel with an external gateway over the wireless communication network, wherein the security credentials are stored in a memory in processing circuitry in the wireless user device and the memory in the processing circuitry is isolated from user circuitry in the wireless user device;
wirelessly transferring, by the wireless user device, a session request to the wireless communication network for a data session with the external gateway; and
routing, by the wireless user device, user data for the data session through the encrypted tunnel to the external gateway, wherein the user circuitry generates the user data for the data session and the processing circuitry routes the user data through the encrypted tunnel to the external gateway.

2. The method of claim 1 further comprising:
wirelessly receiving, by the wireless user device, a provisioning update from the wireless communication network that comprises updated security credentials; and
utilizing, by the wireless user device, the updated security credentials provisioned to the wireless user device to establish a new encrypted tunnel with the external gateway over the wireless communication network.

3. The method of claim 1 wherein the processing circuitry of the wireless user device comprises at least one of a Trusted Platform Module (TPM) or baseband circuitry.

4. The method of claim 1 wherein the memory in the processing circuitry comprises at least one of a Trusted Platform Module (TPM) memory or a baseband circuitry memory.

5. The method of claim 1 wherein the memory in the processing circuitry is not accessible by an operating system and one or more user applications executed by the user circuitry of the wireless user device.

6. The method of claim 1 wherein the external gateway comprises one or more of a security gateway, Virtual Private Network (VPN) gateway, or an Application Server (AS).

7. The method of claim 1 wherein the data session comprises a Protocol Data Unit (PDU) session.

8. A system comprising:
processing circuitry of a wireless user device configured to generate a registration request to register with a wireless communication network for wireless data service;
radio circuitry of the wireless user device configured to wirelessly transfer the registration request to the wireless communication network;
the processing circuitry further configured to utilize, responsive to network registration, security credentials provisioned to the wireless user device prior to the network registration to establish an encrypted tunnel with an external gateway over the wireless communication network, wherein the security credentials are stored in a memory in the processing circuitry and the memory in the processing circuitry is isolated from user circuitry in the wireless user device;
the processing circuitry further configured to generate a session request for a data session with the external gateway;
the radio circuitry further configured to wirelessly transfer the session request to the wireless communication network;
the user circuitry configured to generate user data for the data session; and
the processing circuitry further configured to route the user data for the data session through the encrypted tunnel to the external gateway.

9. The system of claim 8 wherein:
the radio circuitry is further configured to wirelessly receive a provisioning update from the wireless communication network that comprises updated security credentials; and
the processing circuitry is further configured to utilize the updated security credentials provisioned to the wireless user device to establish a new encrypted tunnel with the external gateway over the wireless communication network.

10. The system of claim 8 wherein the processing circuitry of the wireless user device comprises at least one of a Trusted Platform Module (TPM) or baseband circuitry.

11. The system of claim 8 wherein the memory in the processing circuitry comprises at least one of a Trusted Platform Module (TPM) memory or a baseband circuitry memory.

12. The system of claim 8 wherein the memory in the processing circuitry is not accessible by an operating system and one or more user applications executed by the user circuitry of the wireless user device.

13. The system of claim 8 wherein the external gateway comprises one or more of a security gateway, Virtual Private Network (VPN) gateway, or an Application Server (AS).

14. The system of claim 8 wherein the data session comprises a Protocol Data Unit (PDU) session.

15. One or more non-transitory computer readable storage media having program instructions stored thereon, wherein the program instruction, when executed by a computing system, direct the computing system to perform operations, the operations comprising:
directing a radio of a wireless user device to wirelessly transfer a registration request to a wireless communication network to register with the wireless communication network for wireless data service;
responsive to network registration, utilizing security credentials provisioned to the wireless user device prior to the network registration to establish an encrypted tunnel with an external gateway over the wireless communication network, wherein the security credentials are stored in a memory in processing circuitry in the wireless user device and the memory in the processing circuitry is isolated from user circuitry in the wireless user device;
directing the radio to wirelessly transfer a session request to the wireless communication network for a data session with the external gateway; and
routing user data for the data session through the encrypted tunnel to the external gateway, wherein the user circuitry generates the user data for the data session and the processing circuitry routes the user data through the encrypted tunnel to the external gateway.

16. The one or more non-transitory computer readable storage media 15 wherein the operations further comprise:
directing the radio to wirelessly receive a provisioning update from the wireless communication network that comprises updated security credentials; and
utilizing the updated security credentials provisioned to the wireless user device to establish a new encrypted tunnel with the external gateway over the wireless communication network.

17. The one or more non-transitory computer readable storage media 15 wherein the processing circuitry of the wireless user device comprises at least one of a Trusted Platform Module (TPM) or baseband circuitry.

18. The one or more non-transitory computer readable storage media 15 wherein the memory in the processing circuitry comprises at least one of a Trusted Platform Module (TPM) memory or a baseband circuitry memory.

19. The one or more non-transitory computer readable storage media 15 wherein the memory in the processing circuitry is not accessible by an operating system and one or more user applications executed by the user circuitry of the wireless user device.

20. The one or more non-transitory computer readable storage media 15 wherein the external gateway comprises one or more of a security gateway, Virtual Private Network (VPN) gateway, or an Application Server (AS).
